(19) United States
(12) Patent Application Publication
(10) Pub. No.: US 2007/0101410 A1
(43) Pub. Date: May 3, 2007

(54) Method and system using one-time pad data to evidence the possession of a particular attribute

(75) Inventors: Keith Alexander Harrison, Stoke Gifford Bristol (GB); William John Munro, Stoke Gifford Bristol (GB); Martin Sadler, Stoke Gifford Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/523,868

(22) Filed: Sep. 19, 2006

(30) Foreign Application Priority Data
Sep. 29, 2005 (GB) 0519842.9
Sep. 29, 2005 (GB) 0519814.8

(51) Int. Cl. H04L 9/32

(52) U.S. Cl. 726/4

(57) ABSTRACT

A method and system are provided for evidencing to a first entity, such as a visa-checking authority, that a second entity, such as a traveller, possesses a particular attribute, such as right of entry to a specific country. The method involves a preliminary phase of verifying that the second entity has the attribute of interest; associating that attribute with a first one-time pad held by the first entity; and arranging for the second entity to possess a second one-time pad that is at least a subset of the first one-time pad. Thereafter, when the second entity wishes to prove to the first entity that it has the attribute of interest, it passes evidence data derived from the second one-time pad to the first entity. The first entity can then check for the presence, in the first one-time pad, of data matching, or usable to produce, the evidence data.

### FIELD OF THE INVENTION

The present invention relates to a method and system based on the use of one-time pad data, for evidencing that a specific entity possesses a particular attribute.

### BACKGROUND OF THE INVENTION

As is well known, two parties that posses the same secret random data can provably achieve both unbreakable secure communication using the Vernam cipher, and discrimination between legitimate messages and false or altered ones (using, for example, Wegman-Carter authentication). In both cases, however, data used from the secret random data shared by the parties must not be re-used. The term “one-time pad” is therefore frequently used to refer to the secret random data shared by the parties and this term, or its acronym “OTP”, is used herein for secret random data shared by more than one party. Although for absolute security the one-time pad data must be truly random, references to one-time pads (OTP) herein includes secret data that may not be truly random but is sufficiently random as to provide an acceptable degree of security for the purposes concerned.

The fact that the OTP data is effectively consumed when used gives rise to a major drawback of the employment of OTP cryptographic systems, namely that the OTP must be replenished.

One approach to sharing new OTP data between two parties is for one party to generate the new OTP data and then have a copy of the data physical transported in a storage medium to the other party. This is costly to do, particularly where it needs to be done frequently; furthermore, it may not be feasible to adopt this approach (for example, where one of the parties is a communications satellite).

Another approach is to send the OTP data over a communications link encrypted using a mathematically-based encryption scheme. However, this approach effectively reduces the security level to that of the encryption scheme used; since no such schemes are provable secure and may well prove susceptible to attack as a result of advances in quantum computing, this approach is no better than replacing the intended OTP system with a mathematically-based scheme.

More recently, quantum key distribution (QKD) methods and systems have been developed which enable two parties to share random data in a way that has a very high probability of detecting any eavesdroppers. This means that if no eavesdroppers are detected, the parties can have a high degree of confidence that the shared random data is secret. QKD methods and systems are described, for example, in U.S. Pat. No. 5,515,438 and U.S. Pat. No. 5,999,285. In known QKD systems, randomly polarized photons are sent from a transmitting apparatus to a receiving apparatus either through a fiber-optic cable or free space.

As a consequence of the actual and perceived problems of sharing secret random data, OTP cryptographic systems have generally only been used in applications where the security requirements are paramount such as certain military and government applications.

Because OTP cryptography is generally only employed where very high security is needed, the types of system where it is used are those where other components of the overall system do not significantly compromise the level of security provided by OTP cryptography. In particular, there is little point in using OTP cryptography for passing secret messages between parties if the messages are to be stored or subsequently transmitted in a manner that is significantly less secure. Furthermore, the storage of the OTP data itself represents a security threat and unless the OTP data can be stored in a highly secure manner, it is better to share OTP data only at a time immediately before it is to be consumed.

### SUMMARY OF THE INVENTION

According to a first aspect of the present invention, there is provided a method of evidencing to a first entity that a second entity possesses a particular attribute, the method comprising:
verifying that the second entity possesses said particular attribute and as a consequence, associating said particular attribute with a first one-time pad held by the first entity;
arranging for the second entity to possess a second one-time pad that is at least a subset of the first one-time pad;
passing evidence data derived from the second one-time pad to the first entity;
checking for the presence, in the first one-time pad, of data matching, or usable to produce, the said evidence data, such presence evidencing to the first entity that the second entity possesses said particular attribute.

According to a second aspect of the present invention, there is provided a visa system comprising:
a secure data store;
a visa-issuing sub-system arranged to associate a specific visa attribute with a first one-time pad stored in the secure data store, upon a particular individual being verified as entitled to that attribute; the visa-issuing sub-system being further arranged to provide to a device associated with said particular individual a second one-time pad that is at least a subset of the first one-time pad and serves as an electronic visa; and
a visa-checking sub-system arranged to receive from said device an item of evidence data derived from the second one-time pad, and to check for the presence, in the first one-time pad, of data matching, or usable to produce, said item of evidence data; the visa-checking sub-system being further arranged to accept said presence as evidence that said particular individual is entitled to said attribute.

### BRIEF DESCRIPTION OF THE DRAWINGS

Embodiments of the invention will now be described, by way of non-limiting example, with reference to the accompanying diagrammatic drawings of embodiments of the invention, in which:

FIG. 1 is a diagram of a generalised form of user OTP device used in embodiments of the invention;

FIG. 2A is a diagram illustrating the use of a trusted data store to transfer OTP data;

FIG. 2B is a diagram illustrating the use of a first form of trusted random data generator to generate and distribute OTP data;

FIG. 2C is a diagram illustrating the use of a second form of trusted random data generator to generate and distribute OTP data;

FIG. 3 is a diagram depicting a user OTP device interacting with a distributed data processing system;

FIG. 4 is a diagram illustrating a visa issuing and checking system using OTP data;

### BEST MODE FOR CARRYING OUT THE INVENTION

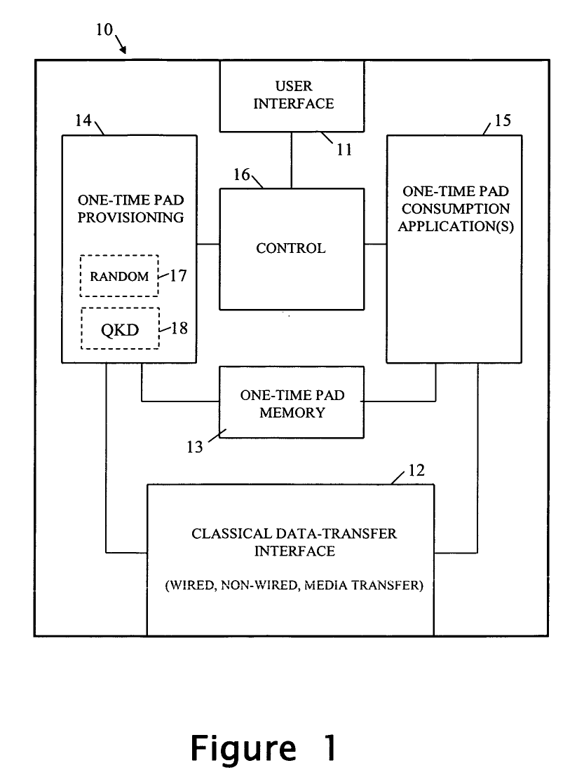

FIG. 1 shows, in generalized form, a user OTP device 10 for storing and using one-time pad data for various applications such as, for example, encryption and identification. Preferred embodiments of the device 10 are portable in form and are, for example, constituted by hand-held devices such as mobile phones and PDAs; however, other embodiments of the apparatus 10 can be of non-portable form such as a personal desktop computer.

In use, the OTP device 10 is intended to communicate with OTP apparatus having access to the same secret random data as the device 10 in order to conduct an OTP interaction (that is, an interaction requiring use of the same OTP data by the device and apparatus). Such OTP apparatus is hereinafter referred to as the “complementary OTP apparatus” with respect to the device 10; this apparatus can be of the same general form as the user OTP device 10 or can be of a different form and/or form part of a distributed system as will be described more fully hereinafter. Generally, the complementary OTP apparatus will be shown with a circular boundary in the Figures and will be referenced ‘20’.

The User OTP Device 10

The user OTP device 10 comprises the following functional blocks:
a user interface block 11 for interfacing with a user;
a classical data-transfer interface 12 for transferring data to and/or from external entities by wired or non-wired means, or by media transfer;
a memory 13 for storing OTP data;
an OTP provisioning block 14 which, through interaction with an external entity, is arranged to provide new secret random data for initializing or replenishing the memory 13 with OTP data;
an OTP consumption block 15 for carrying out one or more applications that consume OTP data stored in memory 13; and
a control block 16 for controlling and coordinating the operation of the other blocks in response to inputs received through the user interface 11 and the data-transfer interface 12.

Typically, the functional blocks 11 to 16 are implemented using a program-controlled processor together with appropriate specialized sub-systems. Further details of each block are given below for the case where a processor-based system (including a main processor and associated memory) is used to carry out at least most of the data processing tasks of the device 10, such tasks including, in particular, the control and coordination tasks of control block 16 and the running of the security applications embodying the OTP consumption block 15.

User Interface 11

The user interface 11 typically comprises an LCD display and an input keypad but may also include audio input and/or output means.

Classical Data-Transfer Interface 12

The classical data-transfer interface 12 can comprise a non-wired interface such as a Bluetooth (Trademark) wireless interface or an IrDA infrared interface; however, a wired interface can alternatively or additionally be provided such as an USB interface (as used herein, the term “wired” is to be understood broadly to cover any type of interface that requires electrical elements to be brought into physical contact). For circumstances where transit delay is not an issue, it is also possible to implement the data-transfer interface 12 as a removable storage medium and related read/write arrangement.

OTP Memory 13

The OTP memory 13 can be part of the general memory associated with the main processor of device 10 or can be formed by a separate memory. In either case, the OTP data is preferably secured against unauthorized access by one or more appropriate technologies. For example, the memory 13 can all be provided in a tamper-resistant hardware package. Alternatively, a protected storage mechanism can be used in which all but the root of a hierarchy (tree) of encrypted data objects is stored in ordinary memory, the root of the hierarchy being a storage root key which is stored in a tamper-resistant hardware package and is needed to decrypt any of the other data objects of the hierarchy. Furthermore, trusted platform techniques can be used to ensure that only authorized software can access the OTP data. It is also possible to use QRAM (Quantum RAM) technologies.

Where the device 10 is designed such that OTP data is consumed immediately following its provisioning, the security requirements of memory 13 can be reduced (unless the device 10 is designed to operate unattended).

OTP Provisioning Block 14

With regard to the OTP provisioning block 14, the most secure way to share secret random data is to use a quantum key distribution method such as described in the documents referenced in the introduction to the present specification. In this case, the OTP provisioning block is provided with a QKD subsystem 17 that can be either a QKD transmitter or a QKD receiver. It is relatively straightforward to incorporate a QKD transmitter within a hand-held device and then to provide a cradle or similar mechanical arrangement to ensure that the device is properly optically aligned to interact with a fixed QKD receiver subsystem. In fact, it is possible to dispense with a mechanical alignment arrangement by the use of an automated or semi-automated alignment system such as is disclosed in our co-pending U.S. patent application Ser. No. 11/454624 filed 1 Jun. 16, 2006.

The OTP provisioning block 14 need not be built around a QKD subsystem and a number of alternative embodiments are possible. Thus, in one such alternative embodiment the OTP provisioning block 14 is simply arranged to store to the OTP memory 13, secret random data received via the data-transfer interface 12 from either:
(i) OTP apparatus seeking to share secret random data with the device 10 either directly or via a trusted data store;
(ii) a trusted random data generator that has the role of generating secret random data and passing it both to the user device 10 and to OTP apparatus with which the device 10 is wishing to interact using shared OTP data

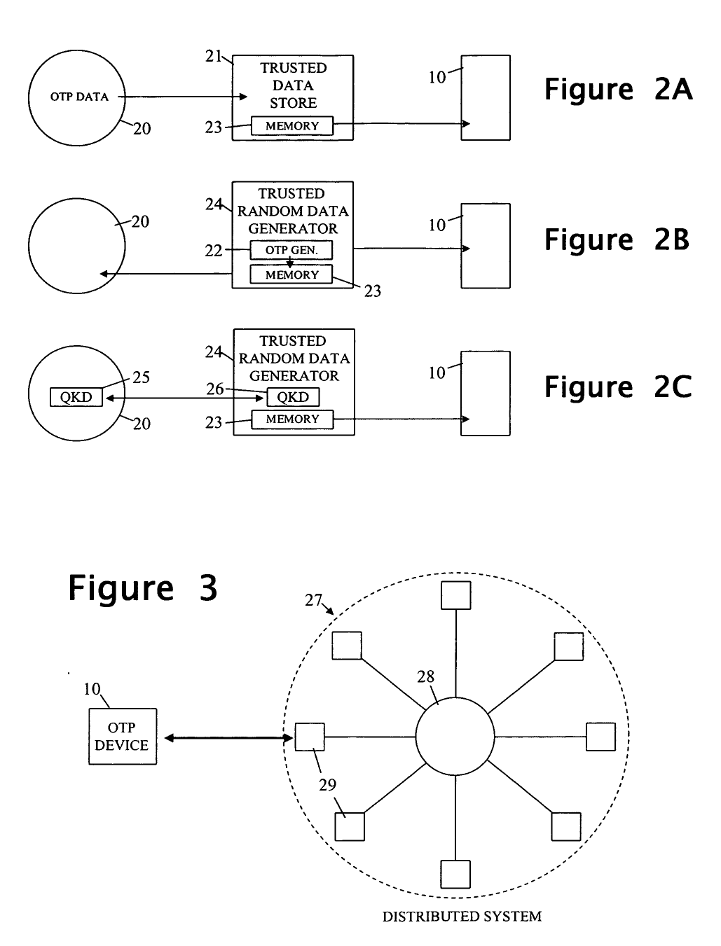

FIG. 2A illustrates the use of a trusted data store 21 for transferring secret random data to the device 10. In FIG. 2A, secret random data provided by the complementary OTP apparatus 20 is first passed to the trusted data store where it is held in memory 23 before being subsequently transferred to the OTP device 10. The trusted data store 21 can be infrastructure equipment or stand-alone equipment such as a hand-held device.

FIG. 2B illustrates the use of a trusted random data generator 24. The trusted generator 24 includes a random data generation arrangement 22 for generating the random data, this data being generated at a time that the trusted random data generator 24 is in communication with the device 10 so that the random data can be passed immediately to the device 10. The trusted random data generator 24 also stores the random data it has generated in memory 23 and subsequently transfers this data to the complementary OTP apparatus 20. It will be appreciated that the random data could have been generated when the generator 24 was in communication with the apparatus 20 and then subsequently passed by the generator 24 to the device10. It would also be possible for the generator 24 to only generate random data when in communication both the device 10 and apparatus 20 so that the random data is passed to both immediately, obviating the need for the memory 23. Conversely, the random data could be generated in advance of the trusted random data generator 24 being in communication with either of the device 10 and apparatus 20 in which case the random data is stored in memory 23 and subsequently passed to each of the device 10 and apparatus.

In the FIG. 2B form of the trusted random data generator 24, the random data is generated by the generator 24 acting alone. FIG. 2C shows a different form of the trusted random data generator 24 in which a QKD arrangement is used to generate the OTP data—in the illustrated scenario, the trusted random data generator 24 includes a QKD transmitter 26 arranged to interact with a QKD receiver 25 in the apparatus 20 in order to generate secret random data. The QKD transmitter 26 and receiver 25 can, of course, be swapped around; furthermore, the OTP data could alternatively be generated by a QKD interaction between the trusted generator 24 and a QKD entity in the device 10. As with the FIG. 2B trusted random data generator 24, the generator 24 of FIG. 2C also includes a memory 23 for storing the generated random data prior to transfer to the device 10 (or to the apparatus 20 if the QKD interaction was with the device 10).

The trusted random data generator 24 can be totally independent of the OTP device 10 and OTP apparatus 20 or can be associated with one of these entities—for example, the trusted random data generator 24 can be run by a bank that also runs the OTP apparatus 20.

Returning now to a consideration of the provisioning block 14 of the device 10, rather than the secret random data being generated using a QKD subsystem or being received by the provisioning block 14 from an external source, the OTP provisioning block 14 can include a random data generator 17 for generating random data which is both used to provision the memory 13 with OTP data, and passed via the data-transfer interface 12 directly or indirectly (including via a trusted data store) to other OTP apparatus with which the device 10 wishes to conduct OTP interactions. The random data generator is, for example, a quantum-based arrangement in which a half-silvered mirror is used to pass/deflect photons to detectors to correspondingly generate a “0”/“1” with a 50:50 chance; an alternative embodiment can be constructed based around overdriving a resistor or diode to take advantage of the electron noise to trigger a random event. Other techniques can be used for generating random data, particularly where a reduced level of security is acceptable—in such cases, some relaxation can be permitted on the randomness of the data allowing the use of pseudo random binary sequence generators which are well known in the art.

Where the secret random data is being received or being passed on via the classical data-transfer interface 12, it is highly desirable for the data to be encrypted (except possibly where a wired interface is being used to interface directly with OTP apparatus or a trusted data store). The encryption should not, of course, be based on the Vernam cipher using existing OTP data from the memory 13 since in this case as least as much OTP data would be consumed as newly provisioned; however the existing OTP data can be used to form a session key for the (relatively) secure transfer of the new secret random data.

It will be appreciated that the level of security that applies to the sharing of secret random data between the device 10 and other OTP apparatus sets the maximum level of security that can be achieved using a one-time pad formed from this data; accordingly, if the user of the device 10 wishes to use the OTP data held in the device 10 to achieve very high levels of security for data transfer from the device, then the initial sharing of the secret random data must involve corresponding levels of security; however, if the OTP data is only to be used for applications that do not warrant the highest levels of security, then the security surrounding secret random data sharing can be relaxed.

It will also be appreciated that the sharing of the secret random data used for the one-time pads is generally restricted to entities that know something about each other (such as their respective identities or some other attribute); accordingly, the sharing of the secret random data will normally be preceded by a verification or qualification process during which each entity satisfies itself that the other entity possesses appropriate attributes. This applies not only for the OTP device 10 and the complementary OTP apparatus 20, but also to the trusted data store 21 and the trusted random data generator 24 which should check the attributes of any entity purporting to entitled to receive OTP data before such data is passed on to that entity.

The provisioning block 14 can simply append newly-obtained secret random data to the existing OTP data in memory 13 or can combine the new secret random data with the existing OTP data using a merge function, the merged data then replacing the previous contents of the memory 13. Preferably, the merge function is such that an eavesdropper who has somehow managed to obtain knowledge of the new secret random data, cannot derive any part of the merged data without also having knowledge of the pre-existing OTP data in the memory 13. A wide range of possible merge functions exist including functions for encrypting the new secret random data using the existing OTP data for the encrypting key, and random permutation functions (it will be appreciated that whatever merge function is used, it must be possible for the complementary OTP apparatus to select and use the same function on its copy of the new secret random data and its existing OTP data). Merging of the new secret random data and existing OTP data otherwise than by aggregation, can only be done if the device 10 and the complementary OTP apparatus have the same existing OTP data which should therefore be confirmed between the device and apparatus before the new secret random data and existing OTP data are subject to merging. In this respect, it will be appreciated that the OTP device 10 and the complementary OTP apparatus may not have the same existing OTP data for a variety of reasons such as a failed communication between the device and apparatus resulting in one of them consuming OTP data but not the other. Of course, it will frequently be possible for the OTP device and the complementary OTP apparatus to cooperate such that if either of them still has OTP data already discarded by the other, then that entity also discards the same data (one method of doing this is described later). However, it will not always be possible for the device 10 and the complementary OTP apparatus to cooperate in this way, or even check whether they have the same existing OTP data, at the time that one or other of the device and apparatus is provided with new secret random data—for example, if the OTP device is being replenished with new secret random data by communication with a trusted random data generator, it may well be that the trusted random data generator is not concurrently in communication with the OTP apparatus, the new secret random data only being subsequently shared with the OTP apparatus. In this type of situation, the new secret random data must be appended to the existing OTP data rather than being merged with it.

OTP Consumption Block 15

The OTP consumption block 15 is arranged to carry out tasks (‘applications’) that require the use (‘consumption’) of OTP data from the memory 13; it is to be understood that, unless otherwise stated herein, whenever data is used from the OTP data held in memory 13, that data is discarded. As already indicated, the OTP consumption block 15 is preferably provided by arranging for the main processor of the device 10 to execute OTP application programs; however, the consumption block 15 can additionally/alternatively comprise specialized hardware processing elements particularly where the OTP application to be executed involves complex processing or calls for high throughput.

A typical OTP consumption application is the generation of a session key for the exchange of encrypted messages with the complementary OTP apparatus; in this case, the complementary OTP apparatus can generate the same session key itself. Of course, the device 10 can securely communicate with the complementary OTP apparatus by encrypting data to be sent using the Vernam cipher—however, this would require the use of as much OTP data as there was data to be exchanged and so give rise to rapid consumption of the OTP data from memory 13.

Another OTP consumption application is the evidencing that the device 10 (or its owner/user) possesses a particular attribute. As already noted, the distribution of the secret random data used for the one-time pads is generally restricted to entities that know something about each other, such as their respective identities or the possession of other particular attributes (in the present specification, reference to attributes possessed by an entity includes attributes of a user/owner of the entity). An example non-identity attribute is an access authorisation attribute obtained following a qualification process that may involve the making of a payment. The secret random data will only be shared after each entity (or a trusted intermediary) has carried out some verification/qualification process in respect of the identity or other attributes of the other entity concerned. This verification/qualification can simply be by context (a bank customer replenishing their device 10 from an OTP apparatus within a bank may be willing to accept that the secret random data being received is shared only with the bank); however, verification/qualification can involve checking of documentary evidence (for example, a paper passport), or an automatic process such as one based on public/private keys and a public key infrastructure. Whatever verification/qualification process is used to control the sharing of secret random data, once such sharing has taken place, OTP data based on the secret random data can be used to prove the identity or other attributes of the possessor of the OTP data. Thus, for example, if OTP apparatus knows that it shares OTP data with an OTP device 10 with identity “X”, then the device 10 can identify itself to the complementary OTP apparatus by sending it a data block from the top of its one-time pad; the apparatus then searches for this data block in the one or more OTP pads it possesses until a match is found in the pad which the apparatus knows it shares with device “X”—as a result, the apparatus knows it is communicating with device “X”. To aid finding a match, the device 10 preferably sends the OTP apparatus an identifier of the one-time pad that the device is proposing to use.

As already noted, communication failures and other issues can result in different amounts of OTP data being held by the OTP device 10 and the complementary OTP apparatus; more particularly, the data at the top of the one-time pad held by device 10 can differ from the data at the top of the one-time pad held by the complementary OTP apparatus. This is referred to herein as “misalignment” of the one-time pads. It is therefore convenient for the OTP device and the complementary OTP apparatus to each obtain or maintain a measure indicating how far it has progressed through its OTP data; this measure can also be thought of as a pointer or index to the head of the OTP pad and is therefore referred to below as the “head index”. Preferably, the head index is taken as the remaining size of the OTP data; although other measurements can be used for the head index (such as how much OTP data has been used), measuring the remaining size of the OTP data can be done at any time and so does not require any on-going maintenance. Whatever actual numeric value of the measure used for the head index, in the present specification the convention is used, when discussing head index values, that the nearer the top of the one-time pad is to the bottom of the pad, the “lower” is the value of the head index.

The head index is used to correct for misalignment of the one time pads held by the device 10A and the complementary OTP apparatus as follows. At the start of any OTP interaction, the device 10 and complementary OTP apparatus exchange their head indexes and one of them then discards data from the top of its one-time pad until its head index matches that received from the other—that is, until the one-time pads are back in alignment at the lowest of the exchanged head index values. When OTP data is used by the device or apparatus in conducting the OTP transaction, the head index is sent along with the OTP interaction data (e.g. an OTP encrypted message) to enable the recipient to go directly to the correct OTP data in its one-time pad; this step can be omitted since although the one-time pads may have become misaligned by the time a message with OTP interaction data successfully passes in one direction or the other between the device and apparatus, this misalignment is likely to be small and a trial-and-error process can be used to find the correct OTP data at the receiving end.

The Complementary OTP Apparatus

With regard to the complementary OTP apparatus with which the OTP device 10 shares the same OTP data and can therefore conduct an OTP-based interaction, this can be constituted by apparatus in which all three functions of OTP storage, provisioning, and consumption are contained within the same item of equipment (as with the device 10); such OTP apparatus is referred to herein as “self-contained” OTP apparatus. However, it is also possible for the complementary OTP apparatus to be distributed in form with one of the OTP storage, provisioning, and consumption functions being in a separate item of equipment from the other two, or with all three functions in separate items of equipment; such OTP apparatus is referred to herein as “distributed” OTP apparatus. In distributed OTP apparatus it is, of course, necessary to ensure an adequate level of security for passing OTP data between its distributed functions. It is conceivable that one or both of the provisioning and consumption functions are provided by equipment that is also used by another distributed OTP apparatus.

To illustrate the different roles that self-contained and distributed OTP apparatus can play, FIG. 3 shows the OTP device 10 conducting an OTP interaction with a distributed data processing system 27 such as a banking system. The distributed system 27 comprises a central computer facility 28 that communicates with a plurality of customer-interfacing units 29 by any suitable communications network. The device 10 can communicate with one or more of the units 29 using its classical data-transfer interface 12.

In one possible scenario, each of the units 29 is a self-contained OTP apparatus holding OTP data that is distinct from the OTP data held by any other unit 29; in this case, assuming that the device 10 only holds one pad of OTP data, it is restricted to interacting with the unit 29 that holds the same pad. Alternatively, the OTP device 10 can be arranged to hold multiple pads of OTP data each corresponding to a pad held by a respective one of the units 29, the device 10 then needing to use data from the correct pad for the unit 29 with which it wishes to conduct an OTP interaction.

In an alternative scenario, the central computer facility 28 is a self-contained OTP apparatus, the device 10 conducting the OTP interaction with the facility 28; in this case, each of the units 29 is simply a communications relay for passing on the OTP interaction messages.

In a further alternative scenario, the central computer facility 28 holds the OTP data shared with the device 10 but the units 29 are consumers of that data; in this case, the device 10 conducts the OTP interaction with one of the units, the unit obtaining the needed OTP data from the facility 28 over the internal network of the distributed system. In this scenario, the distributed system 27 forms a distributed OTP apparatus.

It may be noted that in the last scenario, it is possible to arrange for each of the units 29 to be capable of taking part in an OTP provisioning operation with the device 10, either by passing on to the central computer facility 28 secret random data provided by the device 10, or by generating random data and passing it both to the device 10 and to the central facility 28; in this latter case, the units 29 independently generate their random data.

Whatever the form of the complementary OTP apparatus, it may have been designed to carry out OTP interactions with multiple different devices 10, each with its own OTP data. This requires that the complementary OTP apparatus hold multiple different pads of OTP data, one for each device 10 with which it is to conduct OTP interactions; it also requires that the OTP apparatus uses the correct OTP data when interacting with a particular OTP device 10. One way of enabling the OTP apparatus to determine quickly which is the correct pad of OTP data to use in respect of a particular device 10, is for each pad to have a unique identifier which the device sends to the apparatus when an OTP interaction is to be conducted. It is not necessary for this identifier to be sent securely by the device 10 (unless there are concerns about an eavesdropper tracking patterns of contact between particular devices and the apparatus).

Visa System

As already noted above, OTP data based on secret random data shared by an OTP device and complimentary OTP apparatus can be used by the device to evidence to the apparatus that the device possesses one or more attributes (that may include identity), these being attributes that the apparatus already knows are possessed by the device with which it shares the data concerned.

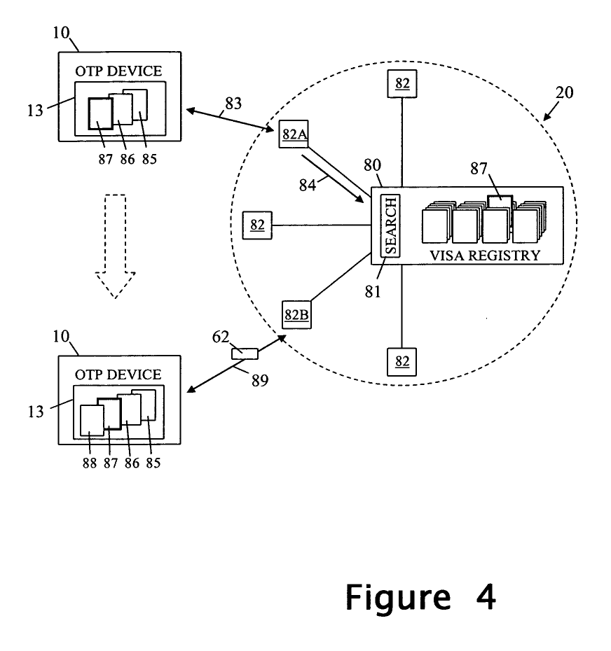

FIG. 4 depicts the use of OTP data in an electronic visa system operated by a national authority. In the FIG. 4 arrangement, visa front offices 82 are linked to a central computerised visa registry 80 by a secure communication network (which can be a computer data network, a network of couriers for transferring data storage media, or a combination of both). The visa front offices 82 comprise at least one visa issuing office 82A and at least one visa checking office 82B. The visa front offices 82 and visa registry 80 together form a distributed OTP apparatus 20.

The visa issuing office 82A comprises secret random data generator (not separately shown) arranged to generate secret random data either by itself or in cooperation with a user OTP device 10 (as would be the case where the data is generated using a QKD arrangement between the office 82A and device 10).

After an individual has been qualified by the visa front office 82A as eligible for a visa, the office 82A generates an electronic visa in the form of a one-time pad 87 and shares all or part of this OTP visa 87 with a user OTP device 10 of the individual concerned (see arrow 83); the OTP visa is also passed over the secure communication network to the visa registry 80 for storage along with associated information about the individual concerned (such as name, address, nationality etc.). The registry 80 holds the OTP visas and associated information on many individuals.

The OTP visa 87 issued to the user device 10 is stored in the secure memory 13 of the device. The memory 13 of the device 13 may already hold similar OTP visas 85 and 86 issued by different national authorities to the one operating the system 20; the national authority operating the system 20 is not made aware of these other visas 85 and 86.

Subsequently, when the user of the device 10 is asked for his/her visa by the visa-checking front office 86B, the user causes the consumption block 14 of the device 10 to transmit evidence data in the form of a data block 62 off the top of the OTP visa 87 to the office 86B. The office 82B sends this data block 62 to the registry 80 (for time efficiency this will generally be done over a computer data network). A search application 81 the searches the registry for the one-time pad 87 that includes the data block 62 provided by the office 82B; again, it is preferable that the allegedly-correct pad 87 is identified to the search application 81 by the office 82B from data provided by the device 10 or by the device user (for example, the user's name can be used for this purpose since the user's name will generally be stored by the registry 80 in association with the one-time pad data). If a match for the data block 62 is found by the search application 81, it returns the associated information to the office 82B and discards the matched data block from the relevant OTP visa 87 held in the registry 80 (if the matched data block is not at the top of the OTP visa, the OTP data above the block is also discarded). If no match is found by the search application 81, the office 82B is informed accordingly.

Since at the time the device 10 interacts with the office 82B the device memory 13 holds multiple OTP visas (in FIG. 4, four OTP visas 85 to 88 as shown), either the user must select the appropriate visa to be used for providing the data block 62, or else the device 10 is arranged to send a data block off every OTP visa it holds (this latter approach being amenable to automatic operation of the device in response to a query message received from the office 82B). This latter approach obviously causes more work for the search application 81 and also has the disadvantage of consuming OTP data from all OTP visas; however, the transmission of data from all OTP visas does not enable the authority operating system 20 to discover what authorities have issued these other visas.

The embodiment of FIG. 4 provide one-way identification, serving to identify a user by name or permissions to an authoritative entity or system. The user has not required a complementary identification of the system to the user; this is because the user context will generally be such as not to require this—in the FIG. 4 embodiment, it is assumed that the user knows he/she is in the front office 82 of the national authority concerned.

It is, of course, possible to arrange for the OTP apparatus to identify itself to the OTP device 10. Where two-way identification is to be effected, the two entities (device 10 and OTP apparatus) preferably proceed as follows:
assume that a first one of the entities has data blocks [a], [b] and [c] at the top of its one-time pad, and that the second of the entities has data blocks [a′], [b′] and [c′] at the top of its one-time pad;
the first entity sends block [a] ⊕ [b] to the second entity where represents the Exclusive OR function;
the second entity checks if [a] ⊕ [b] is the same as [a′]⊕[b′] and if this is the case, the second entity knows that the first entity has the identity/attributes that the second entity associates with the entity with which it shares the one-time pad; if no match is found by the check, the process ceases;
provided the check in the preceding step produced a match (but not otherwise), the second entity now responds by sending [a′]⊕[c′] to the first entity;
the first entity checks that [a′]⊕[c′] is the same as [a] ⊕ [c] and if this is the case, the first entity knows that the second entity has the identity/attributes that the first entity associates with the entity with which it shares the one-time pad;
the first and second entities each discard all blocks used in the exchange(s) with the other entity.

It is also possible to arrange for the first and second entities to generate and exchange the blocks[a] ⊕ [b] and [a′] β [c′] in parallel.

In the foregoing embodiment concerning the use of OTP data to enable a first OTP entity (one of the OTP device 10 and the complementary OTP apparatus) to identify attributes of a second OTP entity (the other of the OTP device 10 and the complementary OTP device), the distributed OTP apparatus 20 formed by the visa front offices 82 and visa registry 80 entity has associated attributes (identity, etc.) with the OTP visa 87 installed in the OTP device10 by some initial process carried out by the apparatus 20 and its operators. However, it is also possible for the OTP apparatus to rely on a trusted party to carry out a verification that the user associated with the OTP visa 87 possesses the attributes before passing on to the apparatus 20, the secret random data to be used for the OTP visa. The trusted authority can be embodied in several ways as set out below.
The trusted authority can be embodied as a trusted data store 21 (see FIG. 2A) that receives secret random data from the user device 10 and is arranged only to pass on this secret random data to the OTP apparatus 20 after verifying that the second entity possesses certain attributes, such as identity, specified by the OTP apparatus.
The trusted authority can be embodied as a trusted random data generator 24 (see FIGS. 2B and 2C) which generates secret random data either by itself or in cooperation with the OTP apparatus 20 and shares this data with the OTP device. However, the trusted random data generator is arranged only to pass on this secret random data to the OTP device after verifying that the OTP device possesses certain attributes specified by the OTP apparatus.

Both of the above embodiments of the trusted authority can be arranged to verify that the OTP apparatus also possesses certain attributes whereby to enable the OTP device to trust that the OTP apparatus with which it shares OTP data possesses these attributes. Thus, where the trusted authority is a trusted data store, the trusted data store can be arranged only to accept secret random data from the OTP apparatus after verifying that the latter possesses particular attributes; similarly, where the trusted authority is a trusted ransom data generator, the trusted random data generator can be arranged only to share secret random data with the OTP apparatus after verifying that the OTP apparatus possesses particular attributes. The attributes to be verified for the first entity will generally be predetermined for the trusted authority concerned as the second OTP entity probably will not have been in prior communication with the trusted authority to specify the attributes it wishes to be verified.

It will be appreciated that many variants are possible to the above described embodiments of the invention.

For example, although in the foregoing, embodiments of the invention have been described in relation to an OTP device that incorporates, in a self-contained form, OTP storage, provisioning, and consumption, it is to be understood that the device could generally be replaced by a distributed arrangement of its functional blocks (for example, in a distributed wearable computer).

1. A method of evidencing to a first entity that a second entity possesses a particular attribute, the method comprising:
verifying that the second entity possesses said particular attribute and as a consequence, associating said particular attribute with a first one-time pad held by the first entity;
arranging for the second entity to possess a second one-time pad that is at least a subset of the first one-time pad;
passing evidence data derived from the second one-time pad to the first entity;
checking for the presence, in the first one-time pad, of data matching, or usable to produce, the said evidence data, such presence evidencing to the first entity that the second entity possesses said particular attribute.

2. A method according to claim 1, wherein the verification that the second entity possesses said particular attribute is carried out by the first entity or by an entity trusted by the first entity.

3. A method according to claim 1, wherein said particular attribute is an identity attribute.

4. A method according to claim 1, wherein said particular attribute is an access privilege attribute.

5. A method according to claim 1, wherein said first entity is a visa system and the second entity is a particular individual with an associated portable device, said second one-time pad being provided to the portable device after verification that said particular individual qualifies for a visa, the second one-time pad serving as an electronic visa issued by the visa system.

6. A method according to claim 5, wherein the portable device holds multiple electronic visas from different visa systems, the portable device only passing the second entity evidence data from the electronic visa issued by the second entity when seeking to prove that said particular individual has a visa issued by the second entity.

7. A method according to claim 5, wherein the portable device holds multiple electronic visas from different visa systems, the portable device passing the second entity data from all the electronic visas held by the device when seeking to prove that said particular individual has a visa issued by the second entity.

8. A method according to claim 1, wherein said evidence data is data directly present in the second one-time pad.

9. A method according to claim 1, wherein said evidence data is data generated by processing data taken from the second one-time pad.

10. A method according to claim 9, wherein said evidence data is produced by combining at least two data blocks taken from the second one-time pad.

11. A visa system comprising:
a secure data store;
a visa-issuing sub-system arranged to associate a specific visa attribute with a first one-time pad stored in the secure data store, upon a particular individual being verified as entitled to that attribute; the visa-issuing sub-system being further arranged to provide to a device associated with said particular individual a second one-time pad that is at least a subset of the first one-time pad and serves as an electronic visa; and
a visa-checking sub-system arranged to receive from said device an item of evidence data derived from the second one-time pad, and to check for the presence, in the first one-time pad, of data matching, or usable to produce, said item of evidence data; the visa-checking sub-system being further arranged to accept said presence as evidence that said particular individual is entitled to said attribute.

12. A system according to claim 11, wherein the visa-checking sub-system is arranged to receive multiple items of evidence data from said device where each such item is derived from an electronic visa issued by a different visa system, the visa-checking sub-system being further arranged to check for said presence, in respect of any of said items.

13. A method according to claim 11, wherein the visa-checking sub-system is arranged to carry out said check for the presence, in the first one-time pad, of data matching, or usable to produce, said item of evidence, by checkin for a direct match in the first one-time pad.

14. A method according to claim 11, wherein the visa-checking sub-system is arranged to carry out said check for the presence, in the first one-time pad, of data matching, or usable to produce, by checking whether said item of evidence data can be derived by processing data taken from the first one-time pad.

15. A method according to claim 14, wherein the visa-checking sub-system is arranged to carry out said processing by combining at least two data blocks taken from the first one-time pad.
